(19) United States
(12) Patent Application Publication
(10) Pub. No.: US 2019/0142678 A1
(43) Pub. Date: May 16, 2019

(54) System And Method For Adjustment Of Muscles, Tendons And Ligaments

(71) Applicants: Chan Su PARK, Los Angeles, CA (US); Seungah Madison LEE, Los Angeles, CA (US)

(72) Inventors: Chan Su PARK, Los Angeles, CA (US); Seungah Madison LEE, Los Angeles, CA (US)

(21) Appl. No.: 15/813,007

(22) Filed: Nov. 14, 2017

(51) Int. Cl. A61H 1/00

(52) U.S. Cl. CPC A61H 1/008; A61H 2201/0157; A61H 2201/1609; A61H 2201/1623; A61H 2201/1253

(57) ABSTRACT

Disclosed are systems and methods for adjustment of muscles, tendons and ligaments comprising a main tool and a secondary tool. The main tool comprises a handle and a striking portion. The secondary tool comprises a receiving portion and a target area contact portion. The target area contact portion is placed on a target area of a patient and the striking portion is used to strike to the receiving portion with sufficient force to properly adjust the target area.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to systems and methods to alleviate pain and/or to prevent injuries by adjusting a patient's muscles, tendons and/or ligaments. Generally, a practitioner would attempt to realign a patient's misaligned bones with just the practitioner's hands. The practitioner would normally either use his or her fist or knuckles on the misaligned bone and use the other hand to strike the first hand in attempting to realign the bone. This traditional method may cause pain to the practitioner as well as the patient. Additionally, this traditional method may not accurate and the force may not be enough to realign the misaligned bone. The present invention solves these problems as well other problems when practitioners attempt to realign a patient's misaligned bones.

### BRIEF SUMMARY OF THE INVENTION

An object of the present invention is a system for adjustment of muscles, tendons and ligaments comprising a main tool and a secondary tool. The main tool comprises: a handle and a striking portion. The secondary tool comprises a receiving portion and a target area contact portion. The target area contact portion is placed on a target area of a patient. The striking portion is used to strike to the receiving portion with sufficient force to properly adjust the target area.

Another object of the present invention is a system for adjustment of muscles, tendons and ligaments wherein the main tool further comprises a weighted portion.

Yet another object of the present invention is a system for adjustment of muscles, tendons and ligaments wherein the striking portion is composed of a flexible material.

Another object of the present invention is a system for adjustment of muscles, tendons and ligaments wherein the flexible material is a rubber.

Yet another object of the present invention is a system for adjustment of muscles, tendons and ligaments wherein the striking portion is composed of a stiff material.

Another object of the present invention is a system for adjustment of muscles, tendons and ligaments wherein the flexible material is a hard plastic.

Yet another object of the present invention is a system for adjustment of muscles, tendons and ligaments wherein the target area contact portion contacts the target area at one point.

Another object of the present invention is a system for adjustment of muscles, tendons and ligaments wherein the target area contact portion contacts the target area at two points.

Yet another object of the present invention is a method for adjustment of muscles, tendons and ligaments with a main tool and a secondary tool. The main tool comprises a handle and a striking portion. The secondary tool comprises a receiving portion and a target area contact portion. The method comprises placing a secondary tool on a target area of a patient and striking the secondary tool with a main tool with sufficient force to properly adjust the target area.

Another object of the present invention is a method for adjustment of muscles, tendons and ligaments wherein the striking portion is composed of a flexible material.

Yet another object of the present invention is a method for adjustment of muscles, tendons and ligaments wherein the flexible material is a rubber.

Another object of the present invention is a method for adjustment of muscles, tendons and ligaments wherein the striking portion is composed of a stiff material.

Yet another object of the present invention is a method for adjustment of muscles, tendons and ligaments wherein the flexible material is a hard plastic.

Another object of the present invention is a method for adjustment of muscles, tendons and ligaments wherein the target area contact portion contacts the target area at one point.

Yet another object of the present invention is a method for adjustment of muscles, tendons and ligaments wherein the target area contact portion contacts the target area at two points.

### BRIEF DESCRIPTION OF THE SEVERAL VIEWS OF THE DRAWING

The advantages and features of the present invention will be better understood as the following description is read in conjunction with the accompanying drawings, wherein:

FIGS. 1A and 1B illustrate embodiments of the main tool of the present invention.

FIGS. 2A, 2B and 2C illustrate embodiments of the secondary tool of the present invention.

FIG. 3 illustrates a representative target areas of the present invention.

FIG. 4 illustrates the use of an embodiment of the present invention.

FIG. 5 illustrates the use of an embodiment of the present invention.

FIG. 6 illustrates the use of an embodiment of the present invention.

FIG. 7 illustrates the use of an embodiment of the present invention.

FIGS. 8A and 8B illustrate the use of an embodiment of the present invention.

FIG. 9 illustrates the use of an embodiment of the present invention.

### DETAILED DESCRIPTION OF THE INVENTION

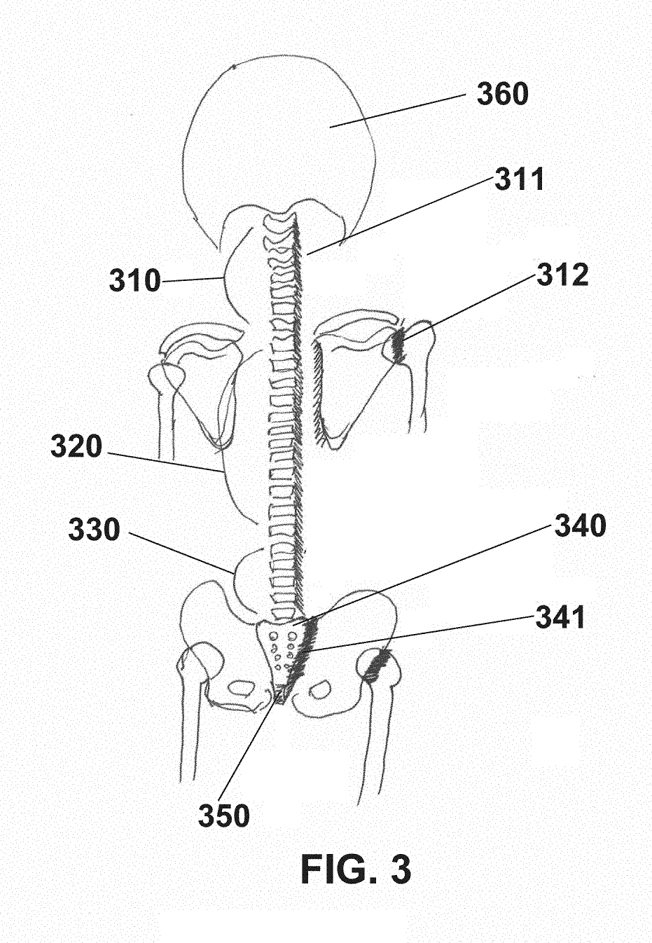

When the tendons and muscles get weak, they hold the attached bones with less power. Sometimes, it dislocates the bones from the proper alignment and our body becomes more susceptible to injury. Chronic or acute pains occur because the misaligned bones can press the nerves, as well as it can cause strains and sprains. The present invention may be utilized to stimulate the weak tendons, ligaments, and muscles so they can help the bones to be in the proper position. The areas treatment includes, but not limited to, cervical vertebrae, lumbar vertebrae, and sacrum. FIG. 3 illustrates various target areas 300 and other associated areas and ailments, including the cervical vertebrae 310, the neck 311, the shoulder 312, the spine 320, the lumbar vertebrae 330, the sacrum 341, sciatica 341, the tailbone 350, and the skull 360.

The present invention may be utilized to treat ailments related to cervical vertebrae 310. The cervical spine 310 is much more mobile than the thoracic or lumbar 330 regions of the spine 320. Unlike the other parts of the spine 320, the cervical spine 310 has transverse foramina in each vertebra for the vertebral arteries that supply blood to the brain. Common symptoms associated with neck pain usually involves one or more of the following: stiff neck; sharp pain; general soreness; radiating pain to arm and fingers; tingling, numbness, or weakness; trouble with gripping or lifting objects; and, headaches and insomnia.

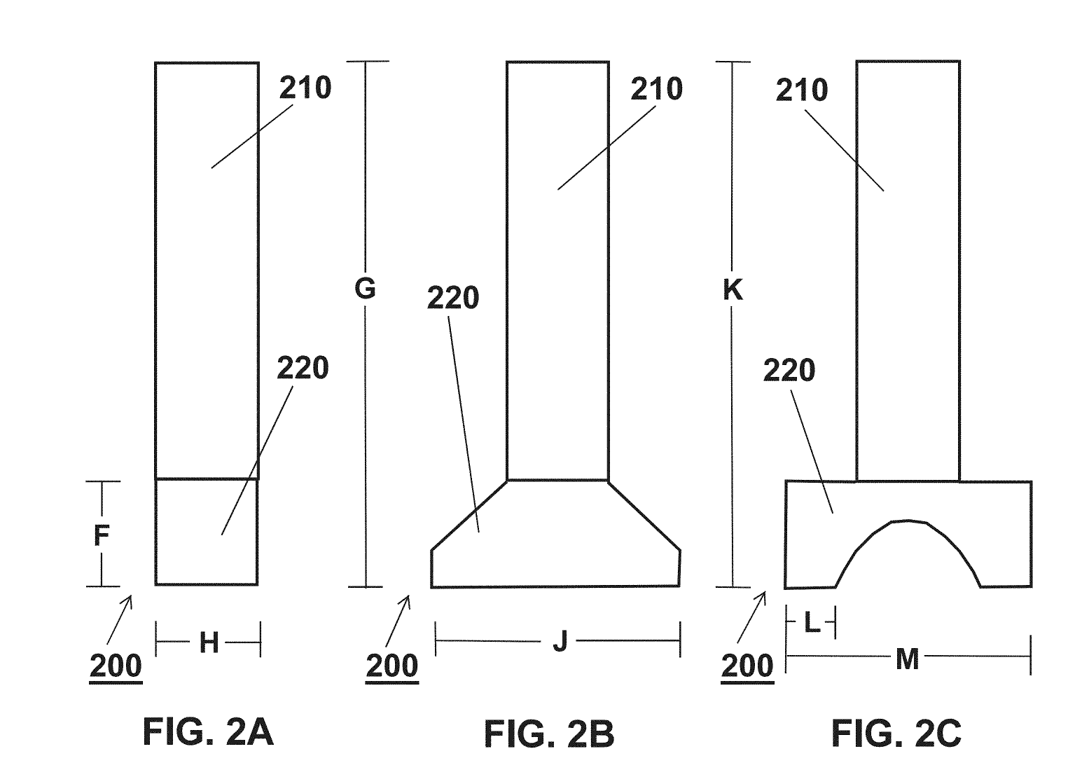

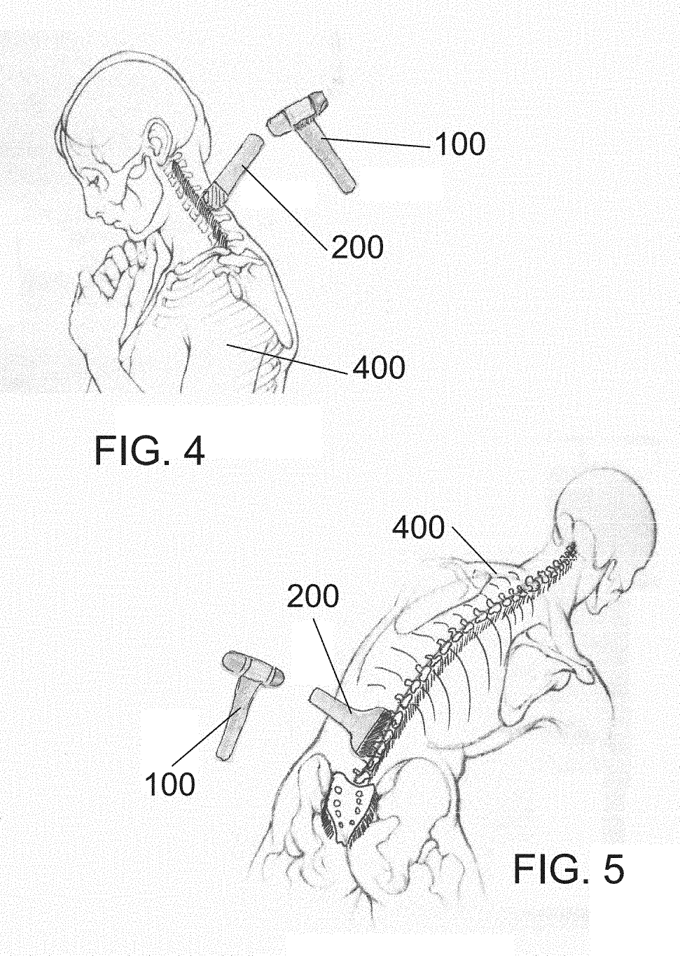

For cervical spine 310 adjustment, as shown in FIG. 4, where the target area 300 involves the cervical vertebrae 310, a practitioner would use the main tool 100 with the secondary tool 200 shown in FIG. 2A. The practitioner first finds the misaligned bone from the center of the body line. Generally, one skilled in the art, such as the practitioner, can locate misaligned bones by touch. The patient 400 bends and turns his or her head to the opposite direction of the misalignment, so the misaligned bone is more distinct or prominent. Then, the practitioner places the secondary tool 200 on the target area 300. Then, the practitioner strikes the secondary tool 200 with the main tool 100 with sufficient force to realign the misaligned bone. For example, if cervical bone 7 (C7) is shifted to the left (misaligned), the patient 400 would turn his or her head to the right. The misaligned bone (i.e., C7) would be more distinctive to the practitioner. The practitioner places the secondary tool 200 on left side of C7 and use the main tool 100 to strike the secondary tool 200, which causes C7 to move towards the center of the body line and to realign C7.

The present invention may be utilized to treat ailments related to lumbar vertebrae 330. The lumbar spine 330, or low back, is a remarkably well-engineered structure of interconnecting bones, joints, nerves, ligaments, and muscles all working together to provide support, strength, and flexibility. However, this complex structure also leaves the low back susceptible to injury and pain. There is a significant overlap of nerve supply to many of the discs, muscles, ligaments, and other spinal structures, and it can be difficult for the brain to accurately sense which is the cause of the pain. For example, a degenerated or torn lumbar disc can feel the same as a pulled muscle—both creating inflammation and painful muscle spasm in the same area. Muscles and ligaments heal rapidly, while a torn disc may or may not. In many cases, the patients 400 with low back pain have uneven pelvic and or sacrum 340. Although low back pains are complicated, they may be relieved more quickly if the spine 320 and supporting bones (pelvis and sacrum 340) are properly aligned. Proper bone alignment is very important because the brain and nerves control the pain and healing process. Once the bones are properly located, the qi and blood circulation gets better and muscle contraction which causes pain will be relaxed as well. The common symptoms of low back pain are dull, aching pain; pain that travels to the buttocks, legs, and feet; pain that is worse after prolonged sitting; pain that feels better when changing positions; and, pain that is worse after waking up and better after moving around.

For lumbar vertebrae 330 adjustment, as shown in FIG. 5, where the target area 300 involves the lumbar vertebrae 330, a practitioner would use the main tool 100 with either the secondary tool 200 shown in FIG. 2A of 2B, depending upon the size of the misaligned bone. The practitioner first finds the misaligned bone from the center of the body line. Generally, one skilled in the art, such as the practitioner, can locate misaligned bones by touch. The patient 400 kneels and leans the upper body forward (child pose), so the misaligned bone is more distinct or prominent. Then, the practitioner places the secondary tool 200 on the target area 300. Then, the practitioner strikes the secondary tool 200 with the main tool 100 with sufficient force to realign the misaligned bone.

The present invention may be utilized to treat ailments related to sacrum 340. Back pain, leg pain, or sciatica 341 can typically arise due to injury where the lumbar spine 330 and sacral region connect (at L5-S1) because this section of the spine is subjected to a large amount of stress and twisting during certain activities, such as sports and sitting for long periods of time. Sometimes left and right side of sacrum 340 is not balanced which can cause sciatic pain as well as low back pain. Even though the pelvis is balanced, the patient 400 can feel the pain due to unbalanced sacrum 340.

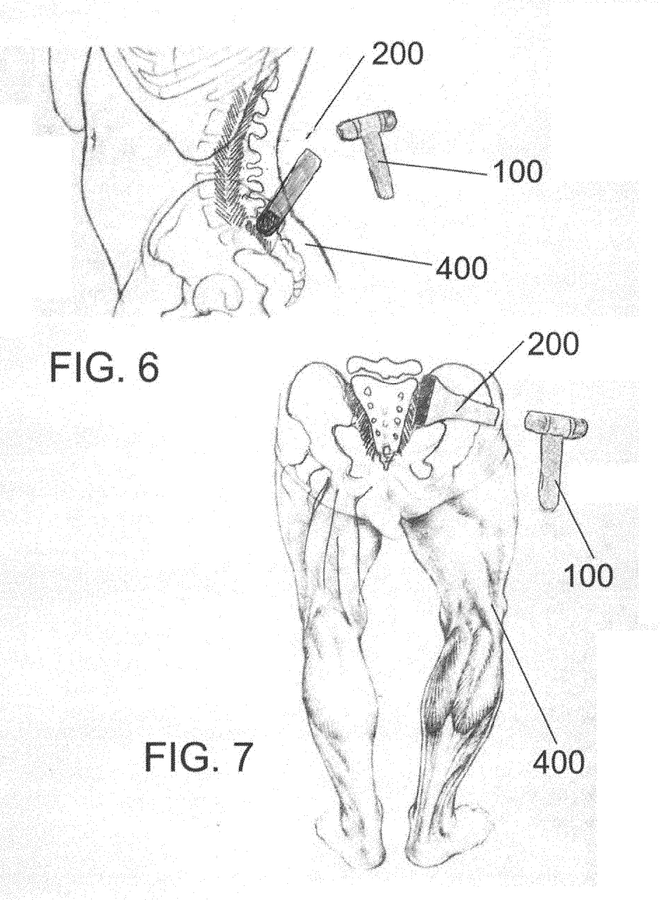

For sacrum 340 adjustment, as shown in FIGS. 6 and 7, where the target area 300 involves the sacrum 340, the sacrum 340 may need to be adjusted in two different manners. A practitioner would use the main tool 100 with either the secondary tool 200 shown in FIG. 2A of 2B, depending upon the size of the target area 300 and the manner of adjustment required to correctly realign the sacrum 340. For example, if the one side of the sacrum 340 is higher than the other side, then the practitioner, as illustrated in FIG. 6, finds the misaligned bone. In this case, the sacrum 340 is triangular pointed down (as shown in FIG. 3) and if misaligned, one side of the sacrum 340 is higher than normal. Generally, one skilled in the art, such as the practitioner, can locate misaligned bones by touch. The patient 400 lays face down. Then, the practitioner places the secondary tool 200, as illustrated in FIG. 2A, on the target area 300. Then, the practitioner strikes the secondary tool 200 with the main tool 100 with sufficient force to realign the misaligned bone. The practitioner would then need to balance the heights by making both sides of equal height. In the other manner, the sacrum 340 may be misaligned from the center of the body line. The practitioner, as illustrated in FIG. 7, finds the misaligned bone from the center of the body line. Generally, one skilled in the art, such as the practitioner, can locate misaligned bones by touch. The patient 400 lays face down. Then, the practitioner places the secondary tool 200, as illustrated in FIG. 2B, on the target area 300. Then, the practitioner strikes the secondary tool 200 with the main tool 100 with sufficient force to realign the misaligned bone.

The sciatic nerve, which extends from the lower back down each leg to the foot, can become pinched or irritated, often resulting in a burning pain and/or tingling sensation down the back of the leg and possibly into the foot. The common term to describe this type of leg pain is sciatica 341.

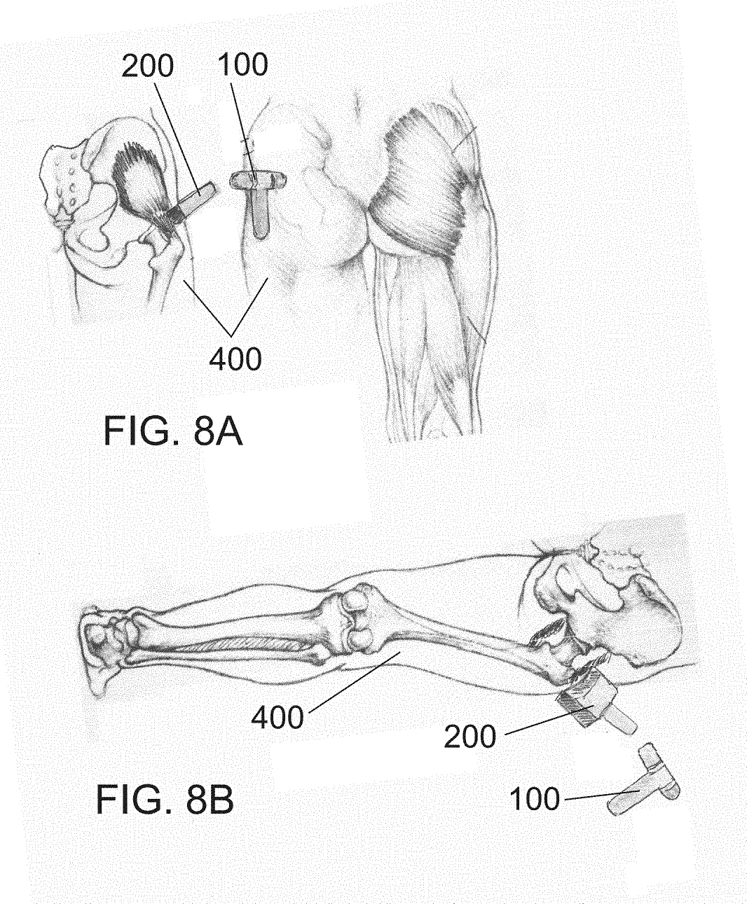

For sciatic pain 341, as shown in FIGS. 8A and 8B, where the target area 300 involves the rectus femoris, a practitioner would use the main tool 100 with the secondary tool 200 shown in FIG. 2C. The practitioner first finds the misaligned bone from the center of the body line, by comparing the right and left sides (femoral area) of the patient. Generally, one skilled in the art, such as the practitioner, can locate misaligned bones by touch. The patient 400 lays on his or her side with the legs straight. Then, the practitioner places the secondary tool 200 on the target area 300, the rectus femoris. Then, the practitioner strikes the secondary tool 200 with the main tool 100 with sufficient force to realign the misaligned bone.

The present invention may be utilized to treat patients suffering from dementia and suppressed or limited brain activity. Dementias are often grouped by what they have in common, such as the part of the brain that is affected or whether they worsen over time (progressive dementias). In patients with Alzheimer's disease, Parkinson's disease and dementia, their skulls may be tilted to left or right causing their skulls to press the brain. The brain activities may be limited due to the pressed capacity along with internal causes, such as built up tau protein, lack of dopamine, etc.

When the patient's brain is tilted to the left (i.e., the left brain is suppressed), the patient may often experience decreased reading, speaking, thinking, and calculation abilities, memory problems, lack of ability to focus on details, and sensory problems (smelling, hearing and tasting). When the patient's brain is tilted to the right (i.e., the right brain is suppressed), the patient may often experience decreased creativity and intuition, lack of control of emotional problems, lack of proper social behavior, difficulty in processing nonverbal information, and lack of control of impulsive behavior. However, these problems are not limited to one side of the brain, as in many cases, the symptoms are a mixture of left or right and hyper or hypo activities. Also, patients with tilted skull (frontal) commonly complain about headache, sudden memory loss, vertigo, and emotional changes like sudden depression.

A practitioner would adjust the patient's skull 360 utilizing the present invention and the patient's symptoms lessen and the patient experiences feelings that the brain is clear, meaning the senses of vision and hearing are clearer and memory improves. For patients with Alzheimer's that were treated with the present invention, their memories increased and their responsiveness to people were more rapid. For patients with Parkinson's that were treated with the present invention, the trembling of their arms and hands decreased and their mobility (walking, sitting and eating) increased significantly.

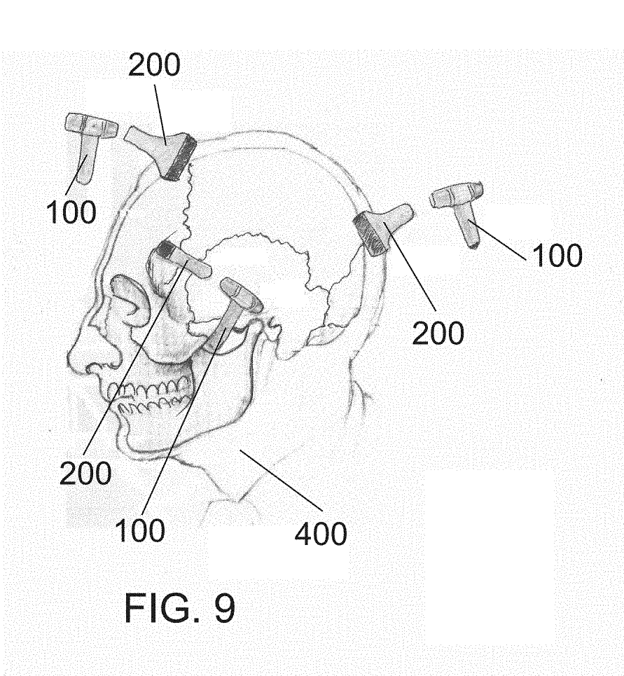

For patients with a tilted brain, as shown in FIG. 9, where the target area 300 involves the skull 360, a practitioner practitioner would use the main tool 100 with the secondary tools 200 shown in FIGS. 2A and 2B, depending upon the point of adjustment of the skull 360, the bone that requires adjustment, the amount of force required, among other factors. If a patient's brain is tilted towards the right, a practitioner places the secondary tool 200 on the first target area 300, the patient's right temple area. Then, the practitioner would strike the secondary tool 200 with main tool 100 with sufficient force to realign the misaligned bone, adjusting the misaligned bone towards the top of the head. Then, the practitioner places the secondary tool 200 on the second target area 300, the patient's frontal area. Then, the practitioner would strike the secondary tool 200 with main tool 100 with sufficient force to realign the misaligned bone, adjusting the misaligned bone towards the left side of the head. Then, the practitioner places the secondary tool 200 on the third target area 300, the patient's left temporal area. Then, the practitioner would strike the secondary tool 200 with main tool 100 with sufficient force to realign the misaligned bone, adjusting the misaligned bone towards the patient's torso. In this example, if looking at the patient's face, the adjustment of the skull 360 is moving the bones in a clockwise direction. As illustrated in FIG. 9, the secondary tool 200 is placed on the lines between the bones of the skull 360.

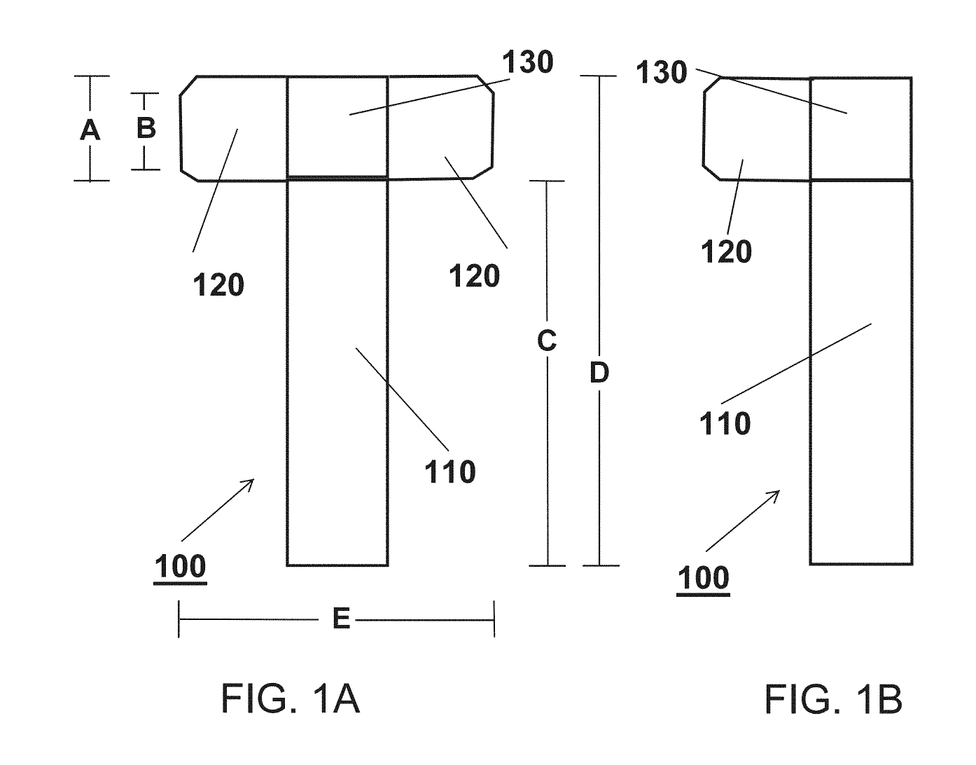

As illustrated in the figures, various embodiments of the present invention, which is a system for adjustment of muscles, tendons and ligaments comprising a main tool 100 and a secondary tool 200. The main tool 100 comprises a handle 110 and a striking portion 120. The secondary tool 200 comprises a receiving portion 210 and a target area contact portion 220. The target area contact portion 220 is placed on a target area 300 of a patient 400. The striking portion 120 is used to strike to the receiving portion 210 with sufficient force to properly adjust the target area 300. The main tool 100, as illustrated in FIGS. 1A and 1B, may further comprises a weighted portion 130. The main tool 100, in both embodiments with and without the weighted portion 130, will have a sufficient weight to effect a sufficient force when the practitioner strikes the secondary tool 200 with the main tool 100. One of ordinary skill in the art understands the sufficient weight necessary to be effective for the main tool 100 to be effective. Similarly, one of ordinary skill in the art, such as a practitioner, would know the amount of force that would be sufficient to apply to the target area 300, based upon the practitioner's experience, the practitioner's knowledge of the patient 400, among other factors. The force applied will be sufficient to cause realigned the bone of the target area 300, but the amount of force applied would not cause discomfort to the patient 400. The target area 300 includes any area that has a bone that is misaligned, which may be either right or left of the center of the body line. Properly adjust means to move and to realign the misaligned bone back towards the center of the body line.

In some embodiments, the striking portion 120 may be composed of a flexible material. In one embodiment, the flexible material is a rubber. In some embodiments, the striking portion 120 may be composed of a stiff material. In one embodiment, the flexible material is a hard plastic.

When a practitioner utilizes the embodiments of the secondary tool 200 illustrated in FIGS. 2A and 2B, the target area contact portion 220 may contact the target area 300 at one point. When a practitioner utilizes the embodiment of the secondary tool 200 illustrated in FIG. 2C, the target area contact portion 220 may contact the target area 300 at two points. The target area contact portions 220 will be made of a material, such as rubber, foam, or other flexible material, that will be comfortable to the patient 400 when the practitioner strikes the secondary tool 200 with the main tool 100. The target area contact portion will be soft enough for the patient's comfort and also stiff and strong enough to allow for the adjustment of the misaligned bone.

The target area contact portions' 220 shapes may be oval, round, square, rectangular, or any shape that facilitates the adjustment and realignment of the misaligned bones towards center. The shapes with corners, such as squares, may have rounded corners.

With regard to the main tool 100 shown in FIGS. 1A and 1B, some preferred dimensions include: A=2.5 cm, B=1.5 cm, C=11.5 cm, D=14 cm, and E=6.5 cm. FIG. 1A illustrates a main tool 100 that is configured with two striking portions 120. In such a configuration, preferably one striking portion 120 is made of a stiff material, such as a hard plastic, and the second striking portion 120 is made of a flexible material, such as a rubber. FIG. 1B illustrates a main tool 100 that is configured with one striking portion 120, which may either be made up of a stiff material, such as a hard plastic, or made of a flexible material, such as a rubber.

With regard to the secondary tool 200 shown in FIG. 2A, some preferred dimensions include: F=2.5 cm, G=11 cm, and H=2.5 cm. In another embodiment, H may equal 1.5 cm. The depth of the target area contact portion 220 equals 2.5 cm.

With regard to the secondary tool 200 shown in FIG. 2B, some preferred dimensions include: G=11 cm and J=9 cm. The depth of the target area contact portion 220 equals 1.5 cm.

With regard to the secondary tool 200 shown in FIG. 2C, some preferred dimensions include: K=13 cm, L=1 cm, and M=9 cm. The depth of the target area contact portion 220 equals 3.5 cm.

The preferred measurements of the main tool 100 shown in FIGS. 1A and 1B and the secondary tools 200 shown in FIGS. 2A, 2B and 2C, are non-limiting examples. The main tool 100 and secondary tool 200 may have dimensions that are suitable for patients 400 that are larger or smaller than the average adult person.

A stiff material needs more force to deform compared to a flexible material. Both the stiff material and flexible material will return to its original shape after striking the secondary tool. Regarding strength, the stiff material is stronger than the flexible material, meaning the stiff material will be able to withstand a greater force and recover to its original shape compared to the flexible material. Regarding hardness, the stiff material is harder than the flexible material, meaning the stiff material has a greater relative resistance that its surface imposes against the penetration of a hard body compared to the flexible material. Regarding toughness; the stiff material is tougher than the flexible material, meaning the stiff material will be able to absorb more energy before fracturing compared to the flexible material. Examples of a flexible materials include, but are not limited to, rubbers, foams, soft plastics (for example, polyurethanes, silicones), and combinations thereof. Examples of a stiff material include, but are not limited to, hard plastics (for example, polycarbonates, polyvinyl chlorides), woods (especially, hardwoods), diamonds, ceramics, metals, alloys, carbon fiber, stone, and combinations thereof. A practitioner would utilize a main tool 100 with a striking portion 120 made of stiff material to apply a greater force and a main tool 100 with a striking portion 120 made of flexible material to apply a lesser force.

Also disclosed is a method for adjustment of muscles, tendons and ligaments with a main tool 100 and a secondary tool 200. The main tool 100 comprises a handle 110 and a striking portion 120. The secondary tool 200 comprises a receiving portion 210 and a target area contact portion 220. The method comprises placing a secondary tool 200 on a target area 220 of a patient 400 and striking the secondary tool 200 with a main tool 100 with sufficient force to properly adjust the target area 300.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A system for adjustment of muscles, tendons and ligaments comprising:
a main tool; and,
a secondary tool;
wherein the main tool comprises:
a handle; and,
a striking portion;
wherein the secondary tool comprises:
a receiving portion; and,
a target area contact portion;
wherein the target area contact portion is placed on a target area of a patient;
wherein the striking portion is used to strike to the receiving portion with sufficient force to properly adjust the target area.

2. The system of claim 1, wherein the main tool further comprises a weighted portion.

3. The system of claim 2, wherein the striking portion is composed of a flexible material.

4. The system of claim 3, wherein the flexible material is a rubber.

5. The system of claim 4, wherein the target area contact portion contacts the target area at one point.

6. The system of claim 4, wherein the target area contact portion contacts the target area at two points.

7. The system of claim 6, wherein the striking portion is composed of a stiff material.

8. The system of claim 7, wherein the flexible material is a hard plastic.

9. The system of claim 8, wherein the target area contact portion contacts the target area at one point.

10. The system of claim 8, wherein the target area contact portion contacts the target area at two points.

11. A method for adjustment of muscles, tendons and ligaments with a main tool and a secondary tool, wherein the main tool comprises a handle and a striking portion; wherein the secondary tool comprises a receiving portion and a target area contact portion, the method comprising:
placing a secondary tool on a target area of a patient; and,
striking the secondary tool with a main tool with sufficient force to properly adjust the target area.

12. The method of claim 11, wherein the main tool further comprises a weighted portion.

13. The method of claim 12, wherein the striking portion is composed of a flexible material.

14. The system of claim 13, wherein the flexible material is a rubber.

15. The system of claim 11, wherein the target area contact portion contacts the target area at one point.

16. The system of claim 14, wherein the target area contact portion contacts the target area at two points.

17. The method of claim 12, wherein the striking portion is composed of a stiff material.

18. The system of claim 17, wherein the flexible material is a hard plastic.

19. The system of claim 18, wherein the target area contact portion contacts the target area at one point.

20. The system of claim 18, wherein the target area contact portion contacts the target area at two points.
